(19) United States
(12) Patent Application Publication
(10) Pub. No.: US 2007/0269358 A1
(43) Pub. Date: Nov. 22, 2007

(54) PROCESSES FOR ABSORBING CHLORINE FROM A GAS CONTAINING CHLORINE AND CARBON DIOXIDE

(75) Inventors: Friedhelm Kamper, Krefeld (DE); Gerhard Moormann, Brunsbuttel (DE); Richard Malchow, Koln (DE); Knud Werner, Krefeld (DE)

Correspondence Address: CONNOLLY BOVE LODGE & HUTZ, LLP, P O BOX 2207, WILMINGTON, DE, 19899, US

(73) Assignee: Bayer Material Science AG, Leverkusen (DE)

(21) Appl. No.: 11/749,803

(22) Filed: May 17, 2007

(30) Foreign Application Priority Data
May 18, 2006 (DE) 102006023939.3

(51) Int. Cl. B01D 53/68

(52) U.S. Cl. 423/241

(57) ABSTRACT

The present invention relates to a process for absorbing chlorine from a gas containing chlorine and carbon dioxide, in particular to a process for washing small amounts of chlorine out of a waste gas stream containing a large excess of carbon dioxide, wherein the washed waste gas can be released directly into the atmosphere.

### BACKGROUND OF THE INVENTION

A known process for the dechlorination of gas mixtures containing carbon dioxide and chlorine includes converting the chlorine into alkali-carbonate-free alkali-chloride-containing alkali hypochlorite in a plurality of absorption stages for chlorine by supplying the stoichiometric amount of alkali hydroxide necessary therefore counter-currently via the last absorption stage.

Another known process for the selective absorption of chlorine from CO₂-containing waste gas, is characterised in that the waste gas is washed with an aqueous solution containing from 0.1 to 10 wt. % NaHCO₃ and from 0.01 to 5 wt. % NaHSO₃.

Another known process for obtaining chlorine from a chlorine-containing gas mixture that additionally contains carbon dioxide as a component, includes compressing and subsequently cooling the mixture, in which a waste gas having a relatively high chlorine content of approximately from 7 to 9 vol. % is formed in the top part of a rectifying column.

Yet another known process for removing halogen gases from a gas stream containing carbon dioxide treats a gas stream coming from a refuse incineration plant (flue gas) in which halogen-containing organic waste is burnt. The process comprises bringing the flue gas into contact in a gas washer containing an aqueous solution of a base and of a reducing agent. Consumed absorption liquid is permanently removed from the gas washer and replaced by fresh absorption liquid. The consumed absorption liquid that is removed is analysed continuously in respect of its residual content of reducing agent and base, and the amount of reducing agent and base added subsequently is controlled accordingly. According to the low chlorine content in the waste gas used of from 50 to 200 parts per 1 million parts (based on the volume), it is regarded as sufficient to reduce the chlorine content to less than half of the initial value.

Such a process can be unsuitable for removing virtually all the chlorine in particular from waste gases having higher chlorine contents. In order to keep the amount of reducing agent and base present in the consumed absorption liquid as low as possible, attempts are made to keep its steady-state concentration in the absorption liquid as low as possible. Although such a system can provide for variations in the concentration of reducing agent and base in case of fluctuations in the halogen concentration in the gas, the procedure is much too sluggish to prevent chlorine from passing through at the top of the gas washer, in particular in the case of sudden fluctuations in the chlorine gas concentration in the waste gas, and notable amounts of chlorine can thus pass into the environment. If, on the other hand, the steady-state concentration of reducing agent in the absorption liquid is kept very high, significant amounts thereof necessarily pass into the waste water, because fresh absorption liquid must be supplied constantly. This is undesirable from both an economic and an ecological point of view.

One object underlying the present invention was to provide a process for absorbing chlorine from a gas containing chlorine and carbon dioxide, which process requires as little reducing agent and base as possible, in relation to the amount of chlorine removed, and preferably, at the same time is capable of removing chlorine virtually completely even from gases having a high chlorine content and is also capable of effectively preventing chlorine from passing through at the top of the absorption column even at peaks in the chlorine content.

### SUMMARY OF THE INVENTION

The present invention relates generally to a process for absorbing chlorine from a gas containing chlorine and carbon dioxide, and in particular, to a process for washing small amounts of chlorine out of a waste gas stream containing a large excess of carbon dioxide, wherein the washed waste gas can be ecologically released directly into the atmosphere. The waste gas can preferably be a so-called “purge gas” of the Deacon process.

The present inventors have found that the aforementioned object can be achieved by a process in which chlorine is absorbed from a gas in at least two stages, it being possible for the first absorption stage to be carried out with virtually complete consumption of the reducing agent.

One embodiment of the present invention provides a process for absorbing chlorine from a gas containing at least chlorine and carbon dioxide, which process comprises: bringing the gas containing chlorine and carbon dioxide into contact, in a first stage, with a first aqueous solution containing one or more bases and one or more reducing agents and, in a second stage, bringing the gas resulting from the first stage (also referred to herein as “the intermediate gas”) into contact with a second aqueous solution containing one or more bases and one or more reducing agents.

### BRIEF DESCRIPTION OF THE SEVERAL VIEWS OF THE DRAWING

The foregoing summary, as well as the following detailed description of the invention, will be better understood when read in conjunction with the appended drawings. For the purpose of illustrating the invention, there is shown in the drawing an embodiment which is presently preferred. It should be understood, however, that the invention is not limited to the precise arrangements and instrumentalities shown.

In the drawing:

FIG. 1 is a schematic representation of a process design in accordance with one embodiment of the present invention.

### DETAILED DESCRIPTION OF THE INVENTION

As used herein, the singular terms “a” and “the” are synonymous and used interchangeably with “one or more.” Accordingly, for example, reference to “a base” herein or in the appended claims can refer to a single base or more than one base. Additionally, all numerical values, unless otherwise specifically noted, are understood to be modified by the word “about.”

The process according to the invention can optionally also comprise further chlorine washing stages and other stages. However, the process according to various preferred embodiments of the present invention preferably comprises only the two mentioned chlorine-removing stages.

In various preferred embodiments of the process according to the invention, the base used in the first aqueous solution, the second aqueous solution, or both, comprises a compound selected from the group consisting of: sodium hydroxide, sodium carbonate, sodium hydrogen carbonate NaHCO₃), and mixtures thereof.

In various preferred embodiments of the process according to the invention, the reducing agent used in the first aqueous solution, the second aqueous solution, or both, comprises a compound selected from the group consisting of: sodium sulfite, hydrogen peroxide, sodium thiosulfate, sodium bisulfite (NaHSO₃), and mixtures thereof

In certain particularly preferred embodiments, the base includes sodium hydroxide and the reducing agent includes sodium thiosulfate or sodium bisulfite.

The first and second aqueous solutions, which may include the same or different bases and reducing agents, can preferably be a single solution introduced at two separate stages, but may also comprise two distinct solutions.

The reducing agent is most preferably sodium thiosulfate. Based on 1 mole of chlorine to be absorbed and reduced, smaller amounts of sodium thiosulfate and sodium hydroxide solution are required as compared with NaHSO₃, as the reducing agent:

Reduction with

| | NaHSO₃ | Na₂S₂O₃ |
|---|---|---|
| moles of reducing agent | 1 | 0.25 |
| moles of NaOH | 3 | 2.5 |

In other words, less reducing agent and base per mole of chlorine are consumed when using sodium thiosulfate as the reducing agent. This also means that, with the same molar concentration of the components, the Na₂S₂O₃ variant has the higher chlorine-destroying potential per kg of solution, which is important for absorbing chlorine concentration peaks.

In a sodium hydrogen carbonate/sodium thiosulfate system according to an embodiment of the invention, the reactions that can take place in the process include the following:

First, sodium hydroxide in solution reacts with CO₂ present in the gas, preferably in excess, to give NaHCO₃:
CO₂+NaOH [symbol] NaHCO₃

Chlorine can then react with sodium thiosulfate with consumption of NaHCO₃ and release of CO₂:
4 cl₂++10 NaHCO₃+Na₂S₂O₃ [symbol] Na₂SO₄+8 NaCl+10 CO₂+5 H₂O

The balance of the two preceding reaction equations gives:
4 Cl₂+10 NaOH+Na₂S₂O₃ [symbol] Na₂SO₄+8 NaCl+5 H₂O

In accordance with the above stoichiometric equation of the reaction that can take place in a process according to an embodiment of the invention for the removal of the chlorine from a gas, the molar ratio of sodium thiosulfate to Cl₂ in the process is adjusted to greater than or equal to 0.25. Over the entirety of the two stages, the procedure is preferably carried out as stoichiometrically as possible in order to consume the sodium thiosulfate that is used as completely as possible, or in order to prevent sodium thiosulfate from passing into the waste water.

Analogously, when using sodium hydroxide as base, the molar ratio of sodium hydroxide to sodium thiosulfate in the process is adjusted to greater than or equal to 10, more preferably to greater than or equal to 12, in accordance with the stoichiometric equation shown above.

In connection with the use of sodium hydroxide as base, it is pointed out that the sodium hydroxide is converted immediately into sodium hydrogen carbonate in the washing liquid. Sodium hydroxide is therefore fed into the washing liquid, but sodium hydrogen carbonate is present in the washing liquid.

Corresponding preferred molar ratios for other reducing agents or bases can be derived from the stoichiometric equations.

Additionally, in various preferred embodiments, the pH value of the aqueous solutions in the first and/or second stage can be greater than 7, more preferably greater than 8. The pH value in both stages is preferably greater than 7, more preferably greater than 8. If the operation is carried out at pH values lower than 7, there may be a risk of secondary reactions. At the mentioned pH values, a NaHCO₃/CO₂ buffer system forms. Under these conditions, chlorate formation does not occur and the efficiency of the chlorine absorption is better ensured. The establishment of a pH value of >7 via the NaHCO₃/CO₂ buffer system that forms also helps to prevent the formation of sulfur precipitates, which could form at lower pH values by decomposition of the thiosulfate.

Unlike the processes of the prior art, the process according to the invention is suitable also for removing chlorine virtually completely from gases having a high chlorine content, such as, for example, those wherein the concentration of chlorine in the gas mixture used is up to 99.9 vol. %. The lower limit of the chlorine concentration is given almost exclusively by the corresponding statutory limits. This means that it is not sensible from an economic point of view to remove the chlorine from waste gases whose chlorine content is already below the statutory limits. In practice, the chlorine contents of the chlorine- and CO₂-containing gases used are preferably less than 10 vol. %, in particular approximately from 1 to 10 vol. %.

The process can likewise be used in the case of chlorine- and CO₂-containing gases whose concentration of carbon dioxide is up to 99.9 vol. %. The content of carbon dioxide in the gas used is preferably approximately from 10 to 80 vol. %. The remaining gases of the gas mixture generally include: nitrogen, oxygen and noble gases. The majority of the further gases in the gas mixture used is generally constituted by oxygen, which is generally present in an amount of from 1 to 50 vol. %, followed by nitrogen and noble gases in lesser amounts.

With the process according to the invention, the chlorine content of the gas used can preferably be reduced to less than 3 mg/m³, more preferably to less than 1 mg/m³.

In a preferred embodiment of the process according to the invention, the gas is contacted with the first aqueous solution, the second aqueous solution, or both, in a counter-current manner.

Furthermore, the first and/or second stage of the process according to the invention can be carried out in a washing column and/or a jet gas washer.

In a preferred embodiment of the process according to the invention, the process can be used to separate chlorine from a purge gas or off-gas of a Deacon process containing chlorine and carbon dioxide.

Accordingly, another embodiment of the invention relates in particular to a process for the oxidation of hydrogen chloride with oxygen in the presence of at least one catalyst suitable for use in the so-called Deacon process, to form chlorine and water, and for the separation of chlorine from the so-called purge gas of the Deacon process, comprising:
(a) bringing a waste gas stream (e.g., the purge gas) containing chlorine and carbon dioxide into contact, in a first stage, with a first aqueous solution containing one or more bases and one or more reducing agents; and,
(b) in a second stage, bringing the gas resulting from the first stage (i.e., the intermediate gas) into contact with a second aqueous solution containing one or more bases and one or more reducing agents.

By means of the at least two-stage chlorine washing according to the invention, in particular with counter-current guiding of the gas phase and the liquid phase, the thiosulfate content can generally be reduced virtually to zero in the first stage (minimisation of thiosulfate and sodium hydroxide solution consumption) and in the second stage reliable chlorine destruction can still be achieved in the event, for example, of chlorine concentration peaks.

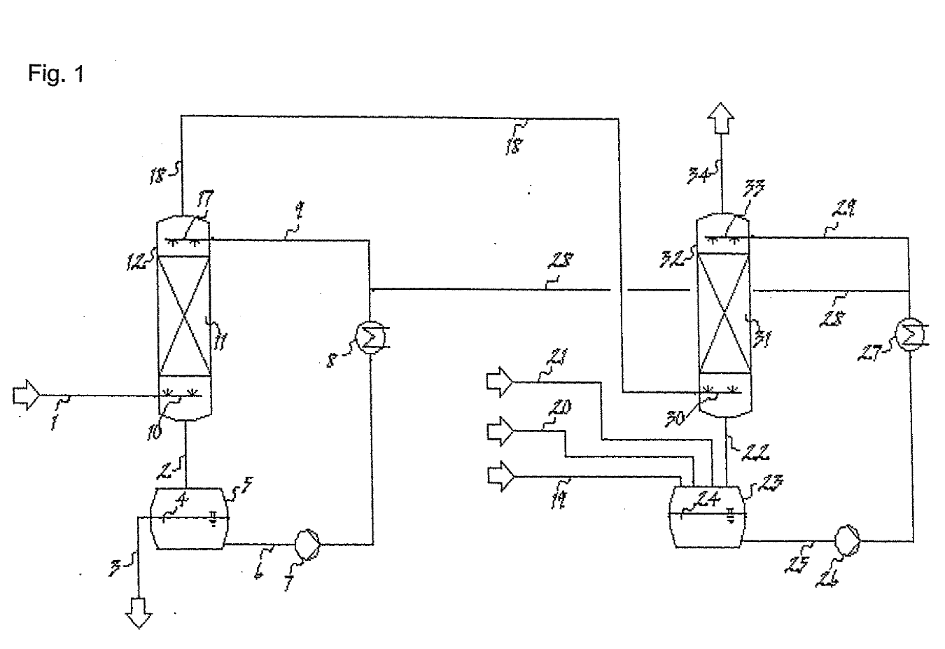

FIG. 1 shows a preferred embodiment for carrying out the process according to the invention for removing chlorine from a waste gas stream containing CO₂.

The chlorine-containing waste gas stream 1 is fed into a first apparatus, which in this drawing is shown in the form of a packed column 12. The packed column 12 contains a packing 11, which can be a structured packing or consists of filling material. Typical examples of structured packings are Mellapak, Montz-Pak or Flexipac. Typical representatives of filling materials are pall rings, Raschig rings, berl saddles or Tellerette rings. A gas distributor 10 can be fitted in the packed column, which gas distributor 10 distributes the chlorine- and CO₂-containing waste gas stream that enters beneath the packing evenly over the cross-section of the column. The column is irrigated with a washing liquid 9, which can likewise be admitted evenly over the cross-section of the packing from the top via a liquid distributor 17.

The washing liquid is removed as a liquid stream 2 at the bottom of the column and is collected in a collecting vessel 5. The liquid level 4 in the collecting vessel 5 can be adjusted, for example, via an overflow line 3.

The collecting vessel 5 is connected to the liquid distributor 17 via a circulatory line 6. The circulation of liquid in line 6 is maintained by the pump 7.

In order to be able to adjust the temperature of the circulating liquid, a heat exchanger 8 can be fitted in the circulatory line 6. Typical types of such an apparatus are plate, tube-bundle, spiral or block heat exchangers.

Fresh washing liquid 28 can be fed into the circulatory line 6 downstream of the heat exchanger 8. The fresh washing liquid 28 preferably contains fresh sodium thiosulfate and sodium hydrogen carbonate, is mixed with the circulating liquid and is admitted as a liquid stream 9 at the top of the column 12. In the column, the chlorine in the waste gas is converted by the sodium thiosulfate into chloride. The thiosulfate required therefor is converted into sulfate and the hydrogen carbonate is converted into CO₂. The washed waste gas 18 contains chlorine in such a low concentration that it can be released directly into the atmosphere. The washing liquid 2 depleted of thiosulfate and hydrogen carbonate is passed into the collecting vessel 5. In the case of the supply of fresh washing liquid 28, some of the liquid is then discharged from the collecting vessel 5 via the overflow line 3. By metering a specific amount of fresh washing liquid 28, matched to the waste gas stream to be washed, the thiosulfate concentration in the collecting vessel 5 and accordingly in the overflow line 3 can be so adjusted that the smallest possible amount of thiosulfate is lost via the overflow line 3. As a result, optimum operation in economic and ecological terms is ensured, because on the one hand thiosulfate is an expensive chemical and on the other hand the waste water is not excessively contaminated.

Another possibility of ensuring optimum operation consists in filling the collecting vessel 5 with fresh washing liquid 28 and then carrying out the process without supplying fresh washing liquid until the thiosulfate concentration in the collecting vessel 5 has fallen to as low a value as possible. The process is then switched to a second collecting vessel filled with fresh washing liquid and is continued further.

Up to this point, the process yields a waste gas stream 18 that can be released directly into the atmosphere only if there are no large fluctuations in the chlorine content in the stream 1.

However, during start-up or shut-down of the plant from which the chlorine-containing waste gas stream 1 comes, such large fluctuations can occur. If, for example, the chlorine content in the stream 1 increases considerably over a very short time, the metering device for fresh washing liquid 28 will not be capable of providing sufficient fresh washing liquid in that short time to wash the increased chlorine stream. In addition, because the washing liquid in the collecting vessel 5 has only a very low thiosulfate content, the washed waste gas stream 18 will consequently still contain chlorine in such an amount that it cannot be released into the atmosphere.

For this reason, the second apparatus, which is preferably identical in terms of construction, is provided downstream of the first.

The washed waste gas stream 18 passes into a second column 32. It contains packing 31, which can likewise be a structured packing or consists of filling material. A gas distributor 30 can also be fitted therein, which gas distributor 30 distributes the waste gas stream 18 that enters beneath the packing evenly over the cross-section of the column. The column is irrigated with a washing liquid 29, which can be admitted evenly over the cross-section of the packing from the top via a liquid distributor 33.

The washing liquid is removed as a liquid stream 22 at the bottom of the column and is collected in a collecting vessel 23. The liquid level 24 in the collecting vessel 23 can be adjusted, for example, via the liquid discharge 28. The fresh sodium thiosulfate solution 19, sodium hydroxide solution 20 and a water stream 21 for dilution, for example, are then fed into the collecting vessel 23. Owing to the supply of sodium hydroxide solution, the ratio of sodium hydrogen carbonate to sodium carbonate in the collecting vessel 23 is established in accordance with the dissociation equilibrium.

The collecting vessel 23 is connected to the liquid distributor 33 via a circulatory line 25. The circulation of liquid in line 25 is maintained by the pump 26.

In order to be able to adjust the temperature of the circulating liquid, a heat exchanger 27 can be fitted in the circulatory line 25. Some of the liquid can be removed downstream of the heat exchanger 27 and fed as fresh washing liquid 28 into the circulatory line 6 of the first column. The remaining liquid 29 is introduced at the top of the column 32.

Because of the CO₂ in the gas stream 18, the sodium carbonate is substantially converted to sodium hydrogen carbonate in the column, and any chlorine still present is converted into chloride by sodium thiosulfate. The thiosulfate used therefor is converted into sulfate and hydrogen carbonate is converted into CO₂. Even where there are large fluctuations in the chlorine content in the gas that is used, the emergent gas stream 34 contains chlorine in such a low concentration that it can be released directly into the atmosphere.

When the first column 12 is operated with a waste gas stream 1 that does not vary greatly in terms of its composition, the gas stream 18 that passes into the second column 32 will not contain chlorine or will contain only a small amount of chlorine. Consequently, scarcely any sodium thiosulfate is consumed in the second column 32.

A relatively high content of sodium thiosulfate is therefore established in the collecting vessel 23, the column 32 and the circulatory line 25. By appropriate calculation of the liquid content in the collecting vessel 23, the column 32 and the circulatory line 25, it is possible to maintain sodium thiosulfate in such an amount that, if there is a sudden increase in the chlorine content in the stream 1, the chlorine can still be washed out reliably in the second column 32: In that case, although it would not be possible for chlorine to be washed out in the first column 12 because the amount of thiosulfate maintained in the collecting vessel 5 and in the circulatory line 6 is not sufficient for the washing out, sufficient thiosulfate for reliably washing out the chlorine is present in the second column 32, in conjunction with its collecting vessel 23 and its circulatory line 25.

In addition, as a result of continuous observation, for example, of the thiosulfate or chlorine content in the region of the first column 12, sufficient time is obtained for a sudden increase in the chlorine content in the stream 1 to be counteracted in the second column 32.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A process comprising:
(a) contacting, in a first stage, a gas comprising chlorine and carbon dioxide with a first aqueous solution comprising a base and reducing agent to form an intermediate gas; and;
(b) contacting, in a second stage, the intermediate gas with a second aqueous solution comprising a base and a reducing agent.

2. The process according to claim 1, wherein the base in either the first stage or the second stage or both comprises a compound selected from the group consisting of sodium hydroxide, sodium carbonate, sodium hydrogen carbonate and mixtures thereof.

3. The process according to claim 1, wherein the reducing agent in either the first stage or the second stage or both comprises a compound selected from the group consisting of sodium sulfite, hydrogen peroxide, sodium thiosulfate, sodium bisulfite and mixtures thereof.

4. The process according to claim 1, wherein the base in either the first stage or the second stage or both comprises a compound selected from the group consisting of sodium hydroxide, sodium carbonate, sodium hydrogen carbonate, sodium sulfite, hydrogen peroxide, sodium thiosulfate, sodium bisulfite and mixtures thereof.

5. The process according to claim 1, wherein the base in either the first stage or the second stage or both comprises sodium hydroxide and the reducing agent in either the first stage or the second stage or both comprises sodium thiosulfate or sodium bisulfite.

6. The process according to claim 1, wherein the reducing agent in either the first stage or the second stage or both comprises sodium thiosulfate.

7. The process according to claim 6, wherein the molar ratio of sodium thiosulfate to chlorine is adjusted to greater than or equal to about 0.25.

8. The process according to claim 6, wherein the molar ratio of sodium thiosulfate to chlorine is adjusted to equal to about 0.25.

9. The process according to claim 6, wherein the base in either the first stage or the second stage or both comprises sodium hydroxide and the reducing agent in either the first stage or the second stage or both comprises sodium hydroxide and the molar ratio of sodium hydroxide to sodium thiosulfate in the process is adjusted to greater than or equal to about 10.

10. The process according to claim 6, wherein the base in either the first stage or the second stage or both comprises sodium hydroxide and the reducing agent in either the first stage or the second stage or both comprises sodium hydroxide and the molar ratio of sodium hydroxide to sodium thiosulfate in the process is adjusted to greater than or equal to about 10 to 12.

11. Process according to claim 1, wherein either the first aqueous solution or the second aqueous solution or both has a pH value greater than 7.

12. The process according to claim 1, wherein the concentration of chlorine in the gas is up to 99.9 vol. %.

13. The process according to claim 1, wherein the concentration of carbon dioxide in the gas is up to 99.9 vol. %.

14. The process according to claim 1, wherein gas further comprises an additional gas selected from the group consisting of: nitrogen, oxygen, noble gases and mixtures thereof.

15. The process according to claim 1, wherein the gas and the first aqueous solution are contacted counter-currently.

16. The process according to claim 1, wherein the intermediate gas and the second aqueous solution are contacted counter-currently.

17. The process according to claim 1, wherein either or both the first stage and the second stage of the process are carried out in an apparatus selected from the group consisting of a washing column and a jet washer.

18. The process according to claim 1, wherein the gas comprises a Deacon process purge gas.

19. A process comprising:
(a) a first stage wherein a gas comprising chlorine and carbon dioxide is contacted with a first aqueous solution comprising sodium hydroxide and sodium thiosulfate, to form an intermediate gas; and;
(b) a second stage wherein the intermediate gas is contacted with a second aqueous solution comprising sodium hydroxide and sodium thiosulfate;
wherein the molar ratio of sodium thiosulfate to chlorine is adjusted to greater than or equal to about 0.25; and wherein the molar ratio of sodium hydroxide to sodium thiosulfate in the process is adjusted to greater than or equal to about 10.
